(19) United States
(12) Patent Application Publication
(10) Pub. No.: US 2026/0241488 A1
(43) Pub. Date: Aug. 20, 2026

(54) LASER WELDING DEVICE AND LASER WELDING METHOD

(71) Applicant: HONDA MOTOR CO., LTD., Tokyo (JP)

(72) Inventors: Masayuki SHINTANI, Tokyo (JP); Tomokatsu NISHIYAMA, Tokyo (JP); Takahiro KUBO, Tokyo (JP); Daisuke SUDO, Tokyo (JP); Yasuto OHASHI, Tokyo (JP)

(21) Appl. No.: 19/460,629

(22) Filed: Jan. 27, 2026

(30) Foreign Application Priority Data
Feb. 14, 2025 (JP) 2025-022318

(51) Int. Cl. B23K 26/21; B23K 26/14; B23K 101/36; H02K 15/0278

(52) U.S. Cl. CPC B23K 26/21; B23K 26/14; B23K 2101/36; H02K 15/0278

(57) ABSTRACT

The laser welding device welds, for a plurality of coil ends arranged in a radial direction of a stator core, the coil ends adjacent to each other, and includes: a laser irradiator that irradiates a welding point of the plurality of coil ends with a laser beam; an assist gas injector that is disposed closer to an inside in a radial direction of the stator core in an arrangement direction of the plurality of coil ends and injects an assist gas toward the plurality of coil ends; and a wall member that is disposed between the one end surface of the stator core and the assist gas injector, includes a pair of plate portions extending in a radial direction of the stator core, and is configured to sandwich an upper space of the plurality of coil ends to be welded from both sides in a circumferential direction of the stator core with the pair of plate portions.

### BACKGROUND OF THE INVENTION

This application is based on and claims the benefit of priority from Japanese Patent Application No. 2025-022318, filed on 14 Feb. 2025, the content of which is incorporated herein by reference.

### Field of the Invention

The present invention relates to a laser welding device and a laser welding method.

### Related Art

There has been known a technique in which ends of coils, which are electrical conductors inserted into slots, are made to protrude from an end surface in an axial direction of a stator core for use in a rotating electrical machine and the adjacent ends are melted and joined by irradiation with a laser beam. To maintain the quality and strength of joining, it is necessary to sufficiently reduce an oxygen concentration around a joint point during joining. Furthermore, when the ends of the coils are joined by irradiation with a laser beam, fumes, dust, motes, spatter, and the like are generated near a laser irradiator. The fumes, dust, motes, spatter, and the like result in deterioration of quality of laser welding, and thus are removed by injection of an assist gas that is used to reduce the oxygen concentration around the joint point.

In the related art, a technique has been known in which an annular lid having holes corresponding to ends of coils is provided on a plurality of covers aligned in a circumferential direction in correspondence with slots of a stator core, and each space partitioned by the cover and the lid is used as a flow path for an assist gas (for example, see PCT International Publication No. WO2022/038746).

Patent Document 1: PCT International Publication No. WO2022/038746

### SUMMARY OF THE INVENTION

However, in laser welding using a welding jig according to the related art, all ends of coils protruding from slots of a stator core are covered with a cover and an annular lid to form a flow path for an assist gas, and thus it is necessary to prepare a cover and a lid for each type of stator core (each size, number of slots, and the like). In addition, when neither cover or lid is provided, it is necessary to provide a plurality of assist gas injectors to reduce the oxygen concentration around a plurality of joint points. However, the distance to the joint point increases due to avoidance of interference between the injectors and interference between the injector and the laser beam, resulting in insufficient reduction in the oxygen concentration. Due to these causes, performing laser welding by the method according to the related art makes it difficult to maintain quality, incurs costs, and is not economical.

Therefore, the present invention is intended to provide a laser welding device and a laser welding method that are capable of injecting an assist gas onto coil ends to be welded with a laser beam, regardless of the type of stator core.

(1) A laser welding device that welds, for a plurality of coil ends arranged in a radial direction and protruding from slots on at least one end surface in an axial direction of a stator core, the coil ends adjacent to each other, the laser welding device including:
a laser irradiator that irradiates a welding point of the plurality of coil ends with a laser beam;
an assist gas injector that is disposed closer to an inside in a radial direction of the stator core in an arrangement direction of the plurality of coil ends and injects an assist gas supplied from an assist gas supply source toward the plurality of coil ends; and
a wall member that is disposed between the one end surface of the stator core and the assist gas injector, includes a pair of plate portions extending in a radial direction of the stator core, and is configured to sandwich an upper space, defined above upper end surfaces of the plurality of coil ends, of the plurality of coil ends to be welded from both sides in a circumferential direction of the stator core with the pair of plate portions.

According to (1) above, the upper space of the plurality of coil ends to be welded is sandwiched between the pair of plate portions of the wall member, and thus the laser welding can be performed in a state where an oxygen concentration around the joint point is reduced by the assist gas injector disposed closer to the one end side in the arrangement direction, whereby it is possible to provide an economical laser welding device that can be applied regardless of the type of the stator core.

(2) In the laser welding device according to (1) above, the assist gas injector is disposed closer to the inside (Y2) in the radial direction of the stator core in the arrangement direction of the plurality of coil ends, and is disposed so as to inject the assist gas along the arrangement direction of the plurality of coil ends sandwiched by the wall member and obliquely toward an outside in the radial direction of the stator core.

According to (2) above, fumes, dust, motes, spatter, and the like generated during the laser welding can be discharged toward the outside in the radial direction of the stator core by injection of the assist gas, whereby the risk can be reduced that the fumes, dust, motes, spatter, and the like adhere to other coil ends of the stator core.

(3) In the laser welding device according to (2) above, a space between the pair of plate portions of the wall member is open to the outside in the radial direction of the stator core.

According to (3) above, the fumes, dust, motes, spatter, and the like generated during the laser welding can be more smoothly discharged toward the outside in the radial direction of the stator core by injection of the assist gas, whereby the risk can be further reduced that the fumes, dust, motes, spatter, and the like adhere to other coil ends of the stator core.

(4) In the laser welding device according to any one of (1) to (3) above, the wall member is attached to the assist gas injector.

According to (4) above, since the relative position of the wall member and the assist gas injector is fixed, by simply positioning the wall member relative to the plurality of coil ends to be welded, the plurality of coil ends and the assist gas injector can also be positioned at the same time.

(5) In the laser welding device according to any one of (1) to (4) above, the laser welding device further includes a mover that moves the assist gas injector and the wall member relative to the stator core such that positions of the assist gas injector and the wall member match a phase corresponding to a circumferential position defined by a slot pitch of the stator core, of the plurality of coil ends to be welded in the stator core.

According to (5) above, the assist gas injector and the wall member can be easily matched in phase with the plurality of coil ends to be welded in the stator core.

(6) In the laser welding device according to any one of (1) to (5) above, the laser welding device further includes a clamp jig that is disposed on the one end surface of the stator core and grips the plurality of coil ends protruding from the slots from both sides in the circumferential direction of the stator core, the wall member being disposed in contact with or in close proximity to a surface of the clamp jig.

According to (6) above, the plurality of coil ends clamped by the clamp jig can be easily arranged and positioned between the pair of plate portions of the wall member.

(7) A laser welding method of welding, for a plurality of coil ends arranged in a radial direction and protruding from slots on at least one end surface in an axial direction of a stator core, the coil ends adjacent to each other with a laser beam emitted from a laser irradiator, the laser welding method including:
disposing an assist gas injector that injects an assist gas supplied from an assist gas supply source toward the plurality of coil ends, closer to an inside in a radial direction of the stator core in an arrangement direction of the plurality of coil ends;
disposing a wall member including a pair of plate portions extending in a radial direction of the stator core, between the one end surface of the stator core and the assist gas injector; and
irradiating a welding point of the plurality of coil ends with a laser beam and injecting the assist gas from the assist gas injector toward the plurality of coil ends, in a state where an upper space, defined above upper end surface of the plurality of coil ends, of the plurality of coil ends to be welded is sandwiched between the pair of plate portions from both sides in a circumferential direction of the stator core.

According to (7) above, the upper space of the plurality of coil ends to be welded is sandwiched between the pair of plate portions of the wall member, and thus the laser welding can be performed in a state where an oxygen concentration around the joint point is reduced by the assist gas injector disposed closer to the one end side in the arrangement direction, whereby it is possible to provide an economical laser welding method that can be applied regardless of the type of the stator core.

(8) In the laser welding method according to (7) above, the laser welding method further includes disposing the assist gas injector closer to an inside in the radial direction of the stator core in the arrangement direction of the plurality of coil ends, and injecting the assist gas to the plurality of coil ends in a state where a direction of a central axis of the assist gas injector coincides with the arrangement direction of the plurality of coil ends sandwiched between the pair of plate portions and is inclined obliquely toward an outside in the radial direction of the stator core.

According to (8) above, the fumes, dust, motes, spatter, and the like generated during the laser welding can be discharged toward the outside in the radial direction of the stator core by injection of the assist gas, whereby the risk can be reduced that the fumes, dust, motes, spatter, and the like adhere to other coil ends.

(9) In the laser welding method according to (8) above, a space between the pair of plate portions of the wall member is open to the outside in the radial direction of the stator core.

According to (9) above, the fumes, dust, motes, spatter, and the like generated during the laser welding can be more smoothly discharged toward the outside in the radial direction of the stator core by injection of the assist gas, whereby the risk can be further reduced that the fumes, dust, motes, spatter, and the like adhere to other coil ends.

(10) In the laser welding method according to any one of (7) to (9) above, the wall member is attached to the assist gas injector.

According to (10) above, since the relative position of the wall member and the assist gas injector is fixed, by simply positioning the wall member relative to the plurality of coil ends to be welded, the plurality of coil ends and the assist gas injector can also be positioned at the same time.

(11) In the laser welding method according to any one of (7) to (10) above, the laser welding method further includes moving, before laser irradiation, the assist gas injector and the wall member relative to the stator core such that positions of the assist gas injector and the wall member match a phase corresponding to a circumferential position, defined by a slot pitch of the stator core, of the plurality of coil ends to be welded in the stator core, thereby performing phase matching.

According to (11) above, the assist gas injector and the wall member can be easily matched in phase with the plurality of coil ends to be welded in the stator core.

(12) In the laser welding method according to any one of (7) to (11) above, the laser welding method further includes disposing the wall member in contact with or in close proximity to a surface of a clamp jig disposed on the one end surface of the stator core in a state where the plurality of coil ends protruding from the slots are gripped by the clamp jig from both sides in the circumferential direction of the stator core.

According to (12) above, the plurality of coil ends clamped by the clamp jig can be easily arranged and positioned between the pair of plate portions of the wall member.

According to the present invention, it is possible to provide a laser welding device and a laser welding method that are capable of injecting an assist gas onto coil ends to be welded with a laser beam, regardless of the type of stator core.

### BRIEF DESCRIPTION OF THE DRAWINGS

FIG. 1 is a schematic diagram illustrating a schematic configuration of a laser welding device according to an embodiment;

FIG. 2 is a perspective view illustrating a plurality of coil ends protruding from each of slots of a stator core;

FIG. 3 is a perspective view illustrating an assist gas injector and a wall member of the laser welding device;

FIG. 4 is an enlarged view of part A in FIG. 1;

FIG. 5 is a longitudinal cross-sectional view taken along line C-C in FIG. 4;

FIG. 6 is an enlarged view of part B in FIG. 1;

FIG. 7 is a longitudinal cross-sectional view taken along line D-D in FIG. 6;

FIG. 8 is a plan view illustrating a state before a plurality of coil ends are clamped by a clamp jig of the laser welding device;

FIG. 9 is a plan view illustrating a state after a plurality of coil ends are clamped by the clamp jig of the laser welding device;

FIG. 10 is a flowchart illustrating an embodiment of a laser welding method using a laser welding device;

FIG. 11 is a perspective view illustrating a state in which the assist gas injector and the wall member of the laser welding device are positioned relative to the plurality of coil ends to be welded with a laser beam;

FIG. 12 is a plan view illustrating a state in which the assist gas injector and the wall member of the laser welding device are positioned relative to the plurality of coil ends to be welded with a laser beam;

FIG. 13 is a longitudinal cross-sectional view taken along line E-E in FIG. 12; and

FIG. 14 is a longitudinal cross-sectional view taken along line F-F in FIG. 12.

### DETAILED DESCRIPTION OF THE INVENTION

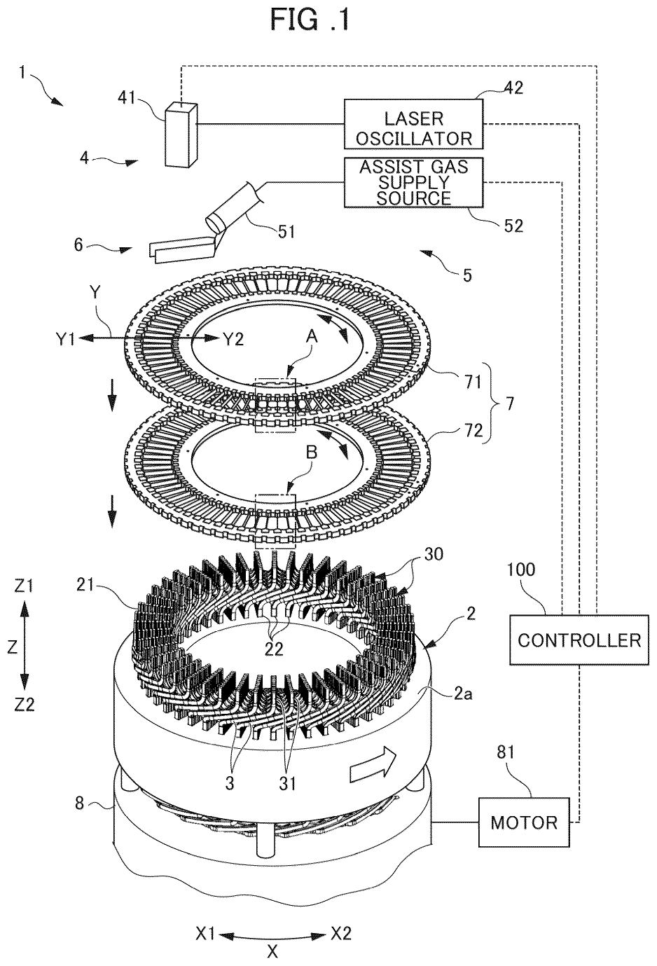

Hereinafter, an embodiment of the present invention will be described in detail with reference to the drawings. FIG. 1 illustrates schematically a general configuration of a laser welding device 1 according to an embodiment. The laser welding device 1 uses a laser beam to weld coil ends 31 of a plurality of segment coils 3 that protrude from one end surface 2a in an axial direction of a stator core 2 used in a rotating electrical machine (not illustrated).

Here, directions indicated by double-headed arrows in each drawing will be defined. “X” indicates a circumferential direction of the stator core 2. “X1” indicates one side in the circumferential direction X, and “X2” indicates the other side in the circumferential direction X. “Y” indicates a radial direction of the stator core 2. “Y1” indicates an outside in the radial direction Y, and “Y2” indicates an inside in the radial direction Y. “Z” indicates an axial direction of the stator core 2. “Z1” indicates one side in the axial direction Z, and “Z2” indicates the other side in the axial direction Z. Although the direction denoted by “Z” does not necessarily coincide with a vertical direction, a case in which the stator core is disposed with the direction Z coincident with the vertical direction will be described in the present embodiment. Therefore, “Z1” indicates an upper side in the vertical direction, and “Z2” indicates a downward side in the vertical direction.

The stator core 2 is formed in an annular shape, and includes a shaft hole 21, in which a rotor (not illustrated) is rotatably accommodated, in a center thereof. The stator core 2 includes a plurality of slots 22 arranged radially in the circumferential direction X. The slots 22 penetrate the stator core 2 in the axial direction Z. A plurality of segment coils 3, which are electrical conductors, are inserted into the slots 22, respectively. Each of the segment coils 3 is formed in a U-shape and includes a pair of legs. The pair of legs of the segment coil 3 are inserted into different slots 22 and 22 in the axial direction Z of the stator core 2. Thus, the pair of legs of each of the segment coils 3 protrude from one end surface 2a of the stator core 2 which is disposed to face the upper side Z1 in FIG. 1.

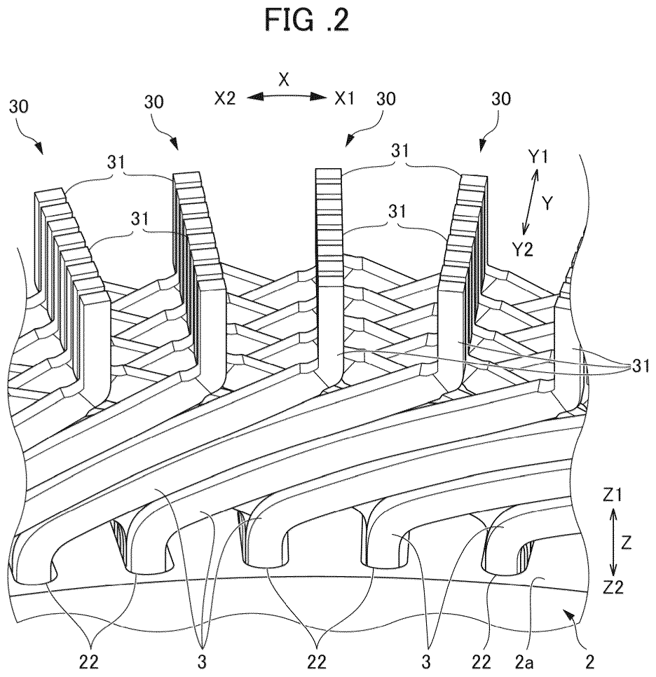

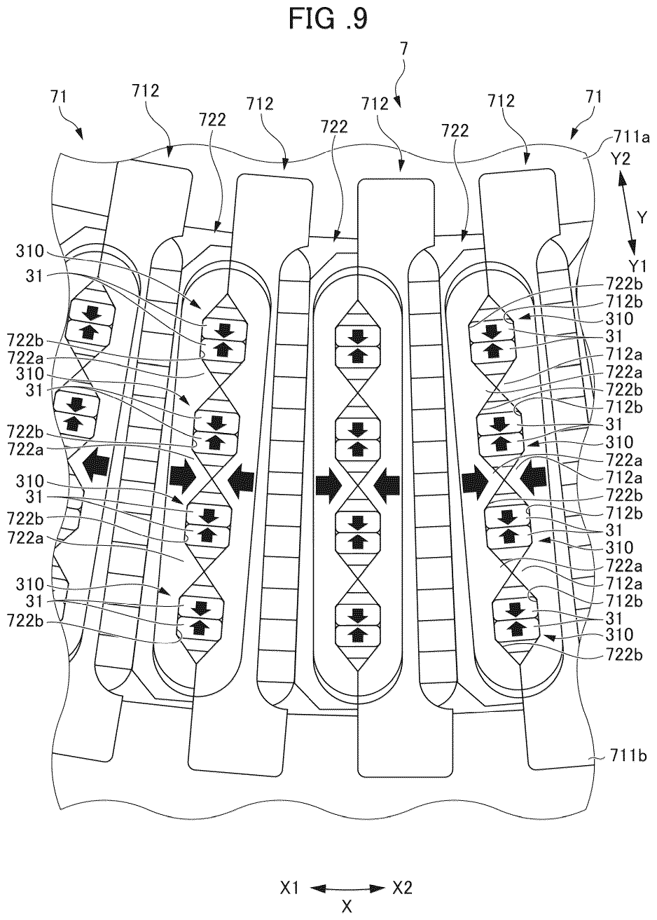

The pair of legs protruding from each of the slots 22 are bent in the circumferential direction X of the stator core 2 as illustrated in FIGS. 1 and 2. Each of the coil ends 31, which are tips of the pair of legs of each of the segment coils 3, is bent so as to rise approximately perpendicular to one end surface 2a of the stator core 2. The coil ends 31 of the plurality of segment coils 3 inserted into the slots 22 are arranged in a row in the radial direction Y of the stator core 2. In an example illustrated in FIG. 2, eight coil ends 31 are arranged in a row in the radial direction Y in each of the slots 22, and form a coil end row 30. The coil end rows 30 are formed in the same number as the slots 22 of the stator core 2, and are arranged radially in the circumferential direction X of the stator core 2. A surface of the segment coil 3 is covered with an insulating film, but the insulating film on each of the coil ends 31 is peeled off for laser welding, whereby a metal portion of the segment coil 3 is exposed. The laser welding device 1 sets, as welding points (joint points) 310 (see FIGS. 9, 11, and 12), tips of two coil ends 31 and 31 adjacent to each other in the radial direction Y within the slots 22, and joins the coil ends 31 and 31 together by irradiating the welding points 310 with a laser beam.

The laser welding device 1 includes a laser irradiation device 4, an assist gas injection device 5, a wall member 6, a clamp jig 7, and a fixing jig 8.

The laser irradiation device 4 includes one laser irradiator 41 that irradiates the welding points 310 of the plurality of coil ends 31 to be welded with a laser beam, and a laser oscillator 42 that generates a laser beam. The laser irradiation device 4 uses the laser oscillator 42 to generate a laser beam having, for example, a wavelength in an infrared region, and uses the laser irradiator 41 to irradiate the welding points 310 of two coil ends 31 and 31 to be welded with the laser beam. As illustrated in FIG. 1, the laser irradiator 41 is disposed closer to the upper side Z1 of one end surface 2a of the stator core 2, and includes therein an optical system that collects the laser beam and a scanner such as a galvanometer mirror that can move the laser beam in a scanning direction. The laser irradiation device 4 is not particularly limited, but a fiber laser device can be used, for example.

The assist gas injection device 5 includes an assist gas injector 51 having a piping structure through which an assist gas can flow, and an assist gas supply source 52 that generates an assist gas and causes the gas to flow through the assist gas injector 51 at a predetermined pressure. As illustrated in FIG. 1, the assist gas injector 51 is disposed between the laser irradiator 41 and one end surface 2a of the stator core 2. The assist gas injector 51 includes an injection port 511 at a tip thereof. The assist gas injector 51 injects an assist gas from the injection port 511 toward the welding points 310 of the plurality of coil ends 31 to be welded.

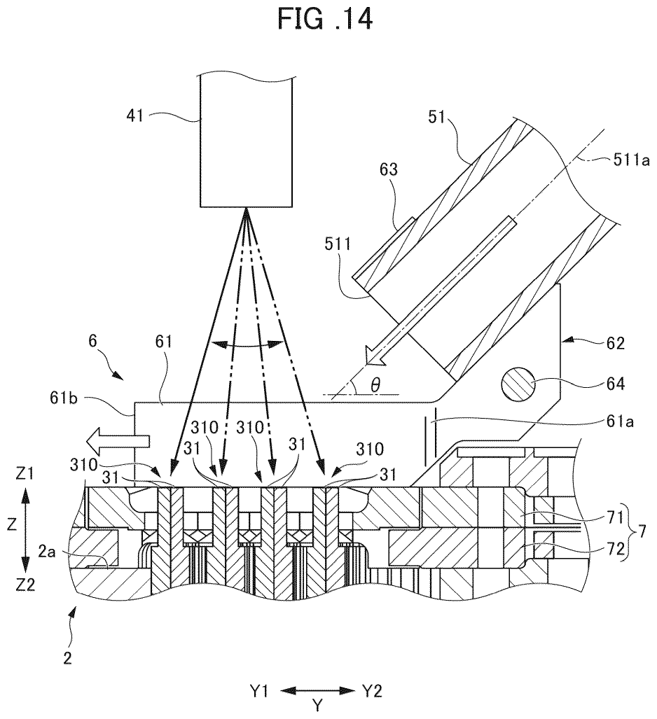

The injection port 511 of the assist gas injector 51 is disposed closer to the inside (Y2) in the radial direction of the stator core in the arrangement direction of the coil end row 30 formed by the plurality of coil ends 31. Specifically, the injection port 511 of the assist gas injector 51 is disposed closer to the inside Y2 of the coil end row 30 in the radial direction Y of the stator core 2, and opens toward the outside Y1 in the radial direction Y of the stator core 2. More specifically, the assist gas injector 51 is disposed obliquely with respect to the one end surface 2a of the stator core 2 from the inside Y2 of the coil end row 30 in the radial direction Y of the stator core 2 toward the outside Y1 in the radial direction Y. In other words, a central axis 511a of the injection port 511 of the assist gas injector 51 is disposed so as to intersect with the one end surface 2a of the stator core 2 at an angle θ smaller than 90° (see FIG. 14). The specific angle θ is not particularly limited, but can be set to 30° to 45°, for example.

The assist gas injector 51 injects the assist gas supplied from the assist gas supply source 52 from the injection port 511 toward the welding points 310 at a predetermined pressure. Thus, an oxygen concentration around the joint points is reduced, and impurities such as fumes, dust, motes, or spatter generated during laser welding are blown away by an injection pressure of the gas. As the assist gas, an inert gas such as argon, neon, nitrogen, or helium can be used.

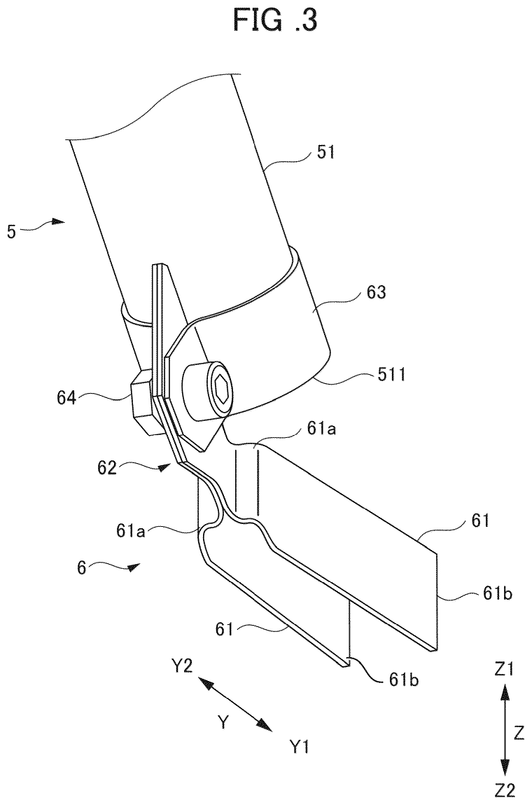

As illustrated in FIG. 1, the wall member 6 is disposed between the one end surface 2a of the stator core 2 and the injection port 511 of the assist gas injector 51. The wall member 6 includes a pair of plate portions 61 and 61 as illustrated in FIG. 3. The pair of plate portions 61 and 61 are disposed at a fixed interval in the circumferential direction X of the stator core 2, and extend substantially parallel to each other in the radial direction Y of the stator core 2. Surface directions of the plate portions 61 and 61 coincide with the radial direction Y of the stator core 2 and the axial direction Z of the stator core 2, respectively.

The plate portions 61 and 61 have the same length in the radial direction Y of the stator core 2. The length of each of the plate portions 61 and 61 can be, for example, equal to or greater than a length in the radial direction Y of the coil end row 30 protruding from the slot 22. A height of each of the plate portions 61 and 61 in the axial direction Z of the stator core 2 is constant in the radial direction Y of the stator core 2. The height of each of the plate portions 61 and 61 can be, for example, equal to or greater than a protruding height of the plurality of coil ends 31 protruding from the clamp jig 7 which will be described below. The wall member 6 sandwiches one row of the coil end rows 30, which protrudes from the stator core 2, from both sides in the circumferential direction X of the stator core 2 with the pair of plate portions 61 and 61, and accommodates all of one row of the coil end rows 30 therein. The pair of plate portions 61 and 61 sandwiching one row of the coil end rows 30 form gas restriction plates on both sides in the circumferential direction X of one row of the coil end rows 30 to restrict the flow of the assist gas injected from the injection port 511. Thus, an ambient gas filling region can be easily formed between the pair of plate portions 61 and 61 by the assist gas injected from the injection port 511.

An end of the one plate portion 61 overlaps with one end of the other plate portion 61. Specifically, as illustrated in FIG. 3, ends 61a and 61a of the pair of plate portions 61 and 61 closer to the inside Y2 in the radial direction Y of the stator core 2 are bent and overlap with each other to form an attachment portion 62 to the assist gas injector 51. The attachment portion 62 is fixed to a mounting pipe 63 attached to a periphery of the tip of the assist gas injector 51 by a fixing member 64 including a bolt and a nut. Thus, the wall member 6 is attached integrally to the tip of the assist gas injector 51.

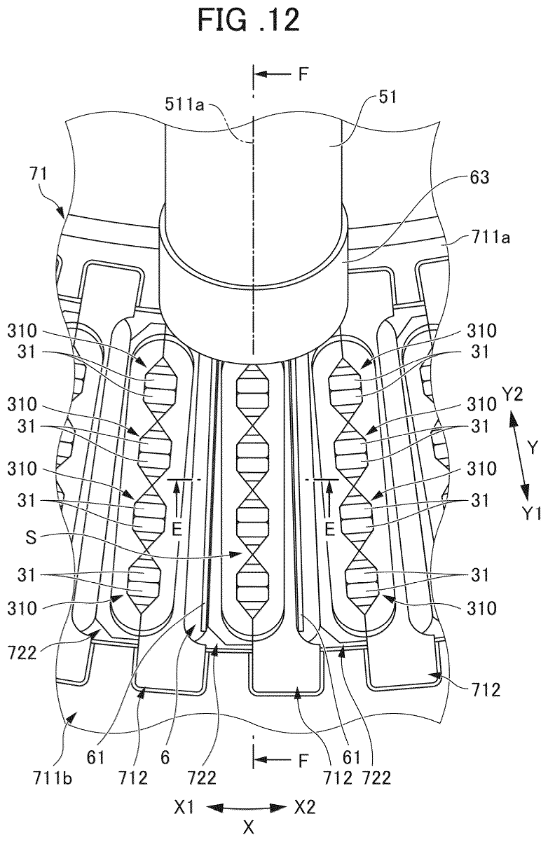

In a state of being attached to the assist gas injector 51, the pair of plate portions 61 and 61 of the wall member 6 extend approximately parallel to the one end surface 2a of the stator core 2 toward the outside Y1 in the radial direction Y of the stator core 2 from the injection port 511. The extending directions of the pair of plate portions 61 and 61 intersect with the central axis 511a of the injection port 511 of the assist gas injector 51 at an angle of intersection θ (see FIG. 14). When the one end surface 2a of the stator core 2 is viewed in plan, the pair of plate portions 61 and 61 extend along the central axis 511a of the injection port 511 of the assist gas injector 51 (see FIG. 12).

Ends 61b and 61b in the pair of plate portions 61 and 61 of the wall member 6 closer to the inside Y2 in the radial direction Y of the stator core 2 are spaced apart from each other in the circumferential direction X of the stator core 2 while maintaining a predetermined interval. The space between the pair of plate portions 61 and 61 is open to the outside Y1 in the radial direction Y of the stator core 2 as illustrated in FIGS. 3, 12, and 14. Therefore, the assist gas injected from the injection port 511 of the assist gas injector 51 is restricted by and flows between the pair of plate portions 61 and 61, and then is smoothly discharged toward the outside Y1 in the radial direction Y of the stator core 2 such that no member obstructs a gas flow between the pair of plate portions toward the outside Y1.

As illustrated in FIG. 1, the clamp jig 7 is disposed between the one end surface 2a of the stator core 2 and the wall member 6. The clamp jig 7 is configured by an upper clamp jig 71 and a lower clamp jig 72. The upper clamp jig 71 and the lower clamp jig 72 are made of a circular ring plate member having the same outer diameter and the same inner diameter.

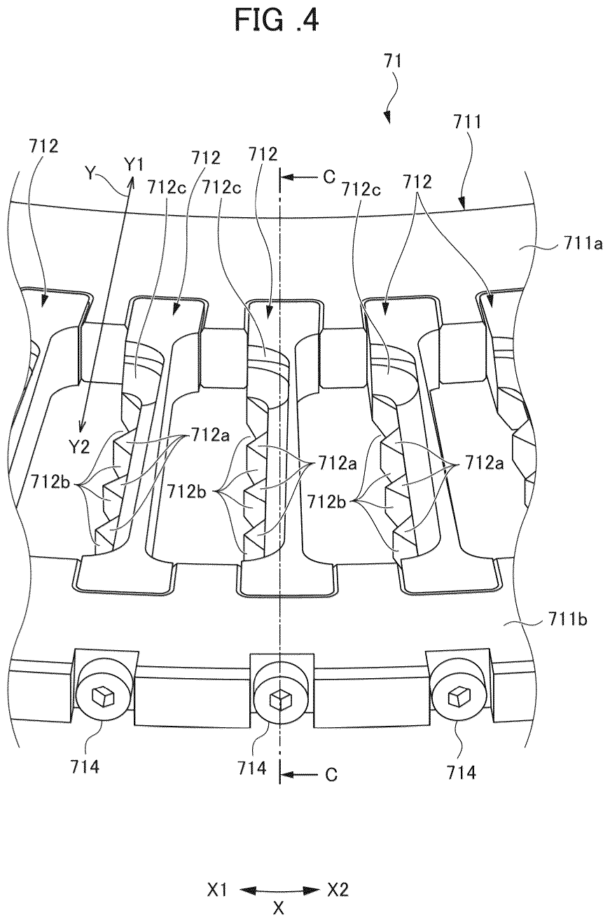

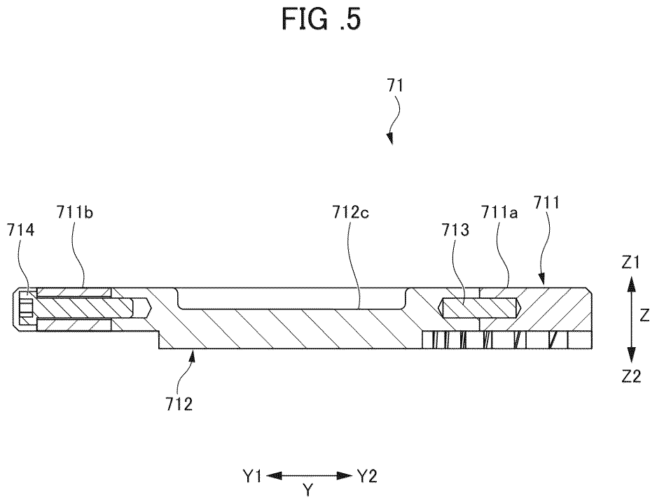

The upper clamp jig 71 includes an upper clamp jig body 711 having a circular ring shape as illustrated in FIGS. 4 and 5. The upper clamp jig body 711 is divided into an inner peripheral ring portion 711a and an outer peripheral ring portion 711b which have a circular ring shape. A clamp half 712 is provided to connect the inner peripheral ring portion 711a and the outer peripheral ring portion 711b of the upper clamp jig body 711. The clamp halves 712 are provided between the inner peripheral ring portion 711a and the outer peripheral ring portion 711b in the same number of as the number of slots 22 of the stator core 2 (that is, the number of coil end rows 30), and are arranged at predetermined intervals in the circumferential direction X of the upper clamp jig body 711. The clamp half 712 is positioned and fixed to the inner peripheral ring portion 711a by a pin 713, and is fixed to the outer peripheral ring portion 711b by a bolt 714 that is screwed from the outside Y1 in the radial direction Y of the outer peripheral ring portion 711b.

As illustrated in FIG. 4, the clamp half 712 includes three guide protrusions 712a that protrude in a mountain shape on one side X1 in the circumferential direction X of the upper clamp jig 71 and are formed at predetermined intervals in the radial direction Y of the upper clamp jig 71. Thus, the clamp half 712 includes four end accommodating recesses 712b that each accommodate two coil ends 31 and 31 and are formed in the radial direction Y on the one side X1 in the circumferential direction X of the upper clamp jig 71. The clamp half 712 has the same thickness in the axial direction Z as the inner peripheral ring portion 711a and the outer peripheral ring portion 711b of the upper clamp jig body 711, but as illustrated in FIGS. 4 and 5, a recess 712c is formed in a region where the guide protrusion 712a and the end accommodating recess 712b are formed, the recess 712c being recessed toward the one side X1 in the circumferential direction X of the upper clamp jig 71.

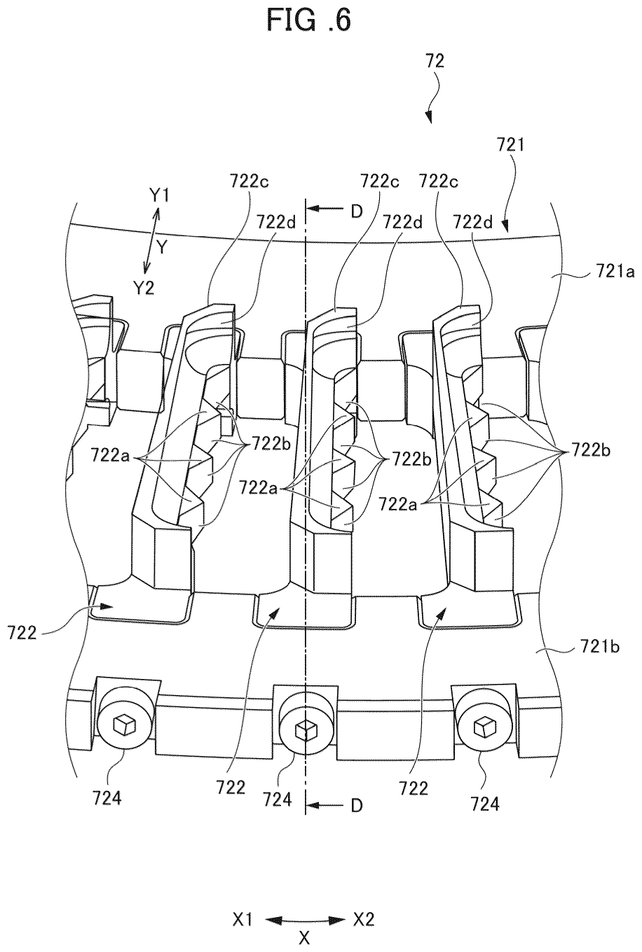

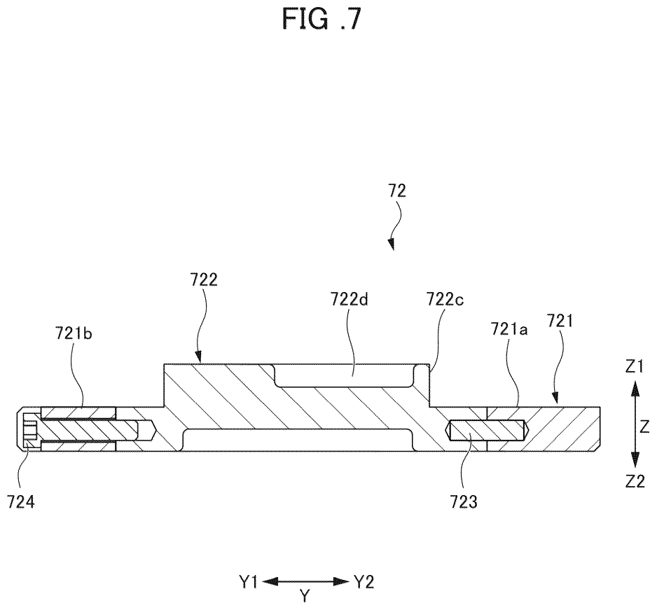

The lower clamp jig 72 includes a lower clamp jig body 721 having a circular ring shape as illustrated in FIGS. 6 and 7. The lower clamp jig body 721 is divided into an inner peripheral ring portion 721a and an outer peripheral ring portion 721b which have a circular ring shape. A clamp half 722 is provided to connect the inner peripheral ring portion 721a and the outer peripheral ring portion 721b of the lower clamp jig body 721. The clamp halves 722 are provided between the inner peripheral ring portion 721a and the outer peripheral ring portion 721b in the same number of as the number of slots 22 of the stator core 2 (that is, the number of coil end rows 30), and are arranged at predetermined intervals in the circumferential direction X of the lower clamp jig body 721. The clamp half 722 is positioned and fixed to the inner peripheral ring portion 721a by a pin 723, and is fixed to the outer peripheral ring portion 721b by a bolt 724 that is screwed from the outside Y1 in the radial direction Y of the outer peripheral ring portion 721b.

As illustrated in FIG. 6, the clamp half 722 includes three guide protrusions 722a that protrude in a mountain shape on the other side X2 in the circumferential direction X of the lower clamp jig 72 and are formed at predetermined intervals in the radial direction Y of the lower clamp jig 72. Thus, the clamp half 722 includes four end accommodating recesses 722b that each accommodate two coil ends 31 and 31 and are formed in the radial direction Y on the other side X2 in the circumferential direction X of the lower clamp jig 72. Both ends of the clamp half 722 in the radial direction Y have the same thickness in the axial direction Z as the inner peripheral ring portion 721a and the outer peripheral ring portion 721b of the lower clamp jig body 721, but as illustrated in FIGS. 6 and 7, a protruding wall portion 722c is formed in a region where the guide protrusion 722a and the end accommodating recess 722b are formed, the protruding wall portion 722c protruding toward the upper side Z1. The protruding wall portion 722c is disposed closer to the one side X1 in the circumferential direction X of the clamp half 722, and forms a recess 722d that is recessed toward the other side X2 in the circumferential direction X.

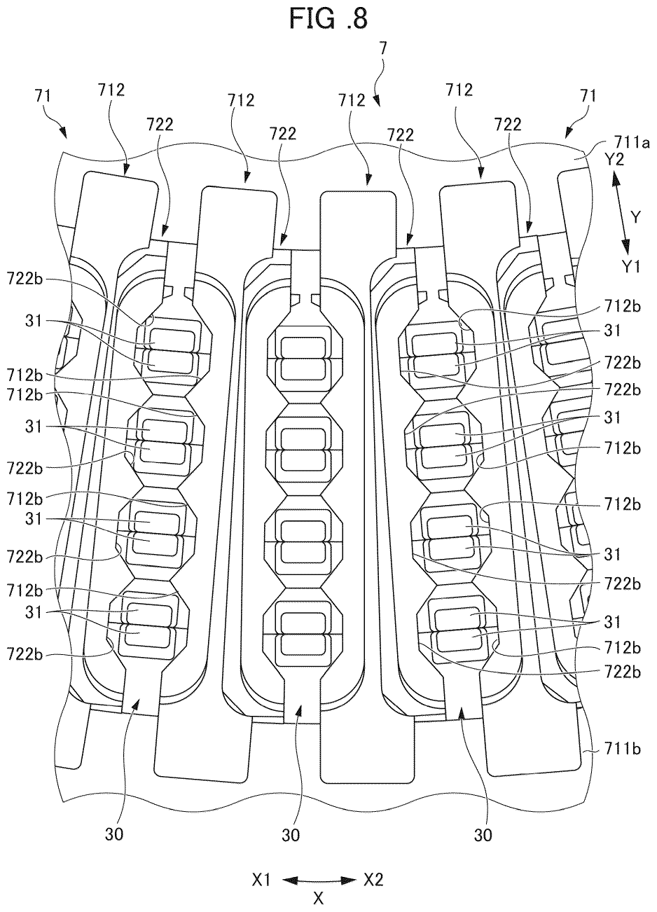

The upper clamp jig 71 is superposed on the lower clamp jig 72 such that the upper clamp jig 71 is disposed closer to the upper side Z1 in the axial direction Z, thereby forming the clamp jig 7. Each of the clamp halves 722 of the lower clamp jig 72 is accommodated between the clamp halves 712 and 712 adjacent to each other in the circumferential direction X of the upper clamp jig 71. The guide protrusions 712a and the end accommodating recesses 712b of the clamp half 712 of the upper clamp jig 71 are disposed to face the guide protrusions 722a and the end accommodating recess 722b of the clamp half 722 of the lower clamp jig 72, respectively, as illustrated in FIGS. 8 and 9.

The clamp jig 7 is disposed close to the one end surface 2a of the stator core 2 by a moving mechanism (not illustrated) during laser welding. Thus, as illustrated in FIG. 8, each of the coil end rows 30 protruding from the stator core 2 is accommodated between the clamp halves 712 and 722 of the clamp jig 7. Between the pair of clamp halves 712 and 722, a coil end row 30 including eight coil ends 31 is disposed. The eight coil ends 31 of the coil end row 30 are accommodated, as a set including two adjacent coil ends 31 and 31, between the four end accommodating recesses 712b of the clamp half 712 of the upper clamp jig 71 and the four end accommodating recesses 722b of the clamp half 722 of the lower clamp jig 72. Upper end surfaces of the eight coil ends 31 between the end accommodating recesses 712b and 722b are disposed substantially on the same surfaces as the upper surfaces of the upper clamp jig 71 and the lower clamp jig 72.

At least one of the upper clamp jig 71 and the lower clamp jig 72 is coupled to a rotating mechanism (not illustrated). The rotating mechanism rotates at least one of the upper clamp jig 71 and the lower clamp jig 72 in the circumferential direction X. Specifically, when only the upper clamp jig 71 is coupled to the rotating mechanism, the upper clamp jig 71 rotates on the one side X1 in the circumferential direction X relative to the lower clamp jig 72 which is immovable. When only the lower clamp jig 72 is coupled to the rotating mechanism, the lower clamp jig 72 rotates on the other side X2 in the circumferential direction X relative to the upper clamp jig 71 which is immovable. When the upper clamp jig 71 and the lower clamp jig 72 are coupled to the rotating mechanism, the upper clamp jig 71 rotates on the one side X1 in the circumferential direction X, and the lower clamp jig 72 rotates on the other side X2 in the circumferential direction X. Thus, the clamp half 712 of the upper clamp jig 71 and the clamp half 722 of the lower clamp jig 72 approach each other, and as illustrated in FIG. 9, the two coil ends 31 and 31 disposed between the end accommodating recesses 712b and 722b are clamped from both sides in the circumferential direction X. The clamped two coil ends 31 and 31 are guided to inclined surfaces of the guide protrusions 712a and 722a, and come into close contact with each other in the circumferential direction X to form the welding points 310, thereby being in a state of a laser welding standby.

As illustrated in FIG. 1, the fixing jig 8 is disposed closer to the downward side Z2 in the axial direction Z of the stator core 2, and fixes and supports the stator core 2 by placing it thereon. The fixing jig 8 is driven by a motor 81 to rotate around the central axis of the stator core 2 at a predetermined pitch (for example, an arrangement pitch of the slots 22). Thus, the fixing jig 8 rotates and moves the stator core 2, which is fixed and supported, in the circumferential direction X. Therefore, the fixing jig 8 and the motor 81 constitute a mover that moves the stator core 2 relative to the laser irradiator 41, the assist gas injector 51, and the wall member 6.

As illustrated in FIG. 1, the laser welding device 1 includes a controller 100. The controller 100 is electrically connected to the laser irradiator 41 and the laser oscillator 42 of the laser irradiation device 4, the assist gas supply source 52 of the assist gas injection device 5, the moving mechanism and the rotating mechanism of the clamp jig 7, and the motor 81, and controls operations of these components to perform laser welding on each of the welding points 310 including two coil ends 31 and 31. The controller 100 operates according to a predetermined program for performing laser welding. The controller 100 includes at least one memory that stores a program, and at least one processor. At least one processor controls the laser oscillator 42, the assist gas supply source 52, the moving mechanism and the rotating mechanism of the clamp jig 7, and the drive of the motor 81 according to a predetermined program for laser welding read from at least one memory. The controller 100 may be provided only for the laser welding device 1. Furthermore, the functions of the controller 100 may be implemented by an external terminal, such as a personal computer (PC) or a tablet terminal, connected to the laser welding device 1.

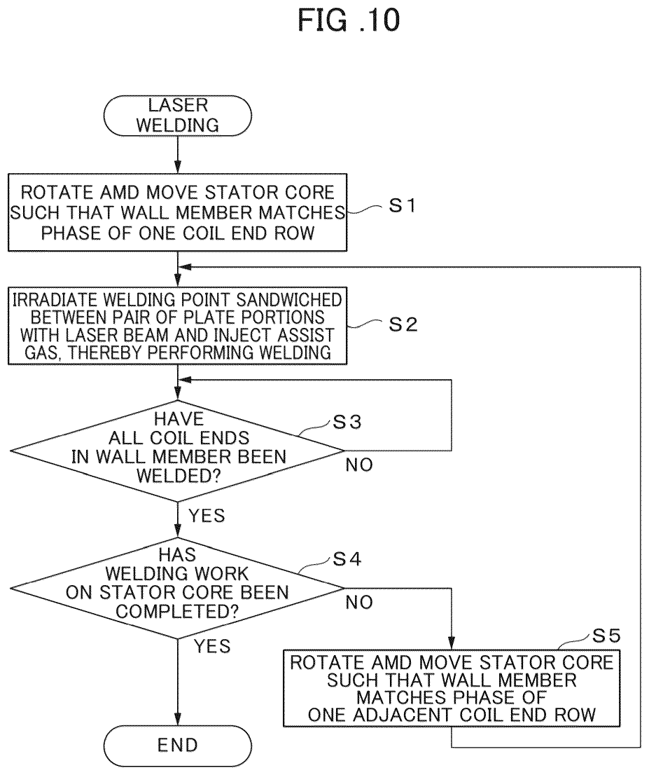

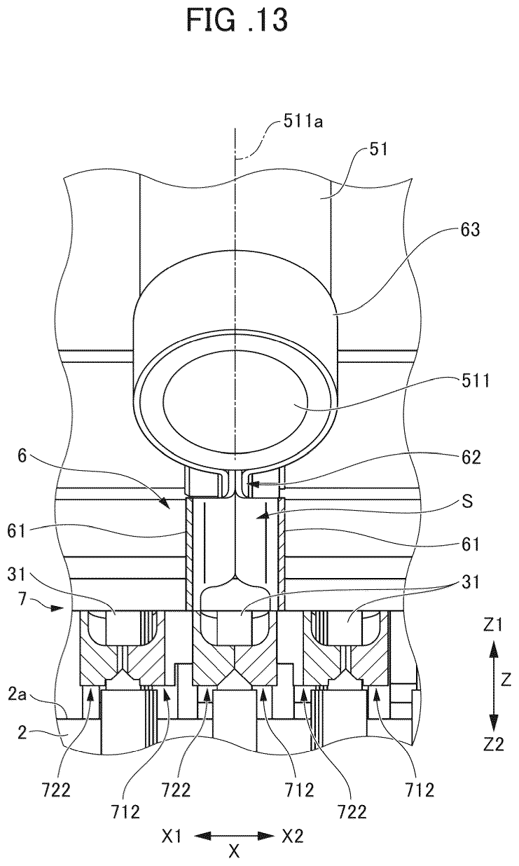

Next, a laser welding method for joining the welding point 310 using the laser welding device 1 will be described with reference to FIGS. 10 to 14. FIG. 10 is a flowchart of laser welding to be performed under control of the controller 100.

In the laser welding device 1 in the laser welding standby state, the assist gas injector 51 and the wall member 6 are disposed above the clamp jig 7. The clamp halves 712 and 722 of the clamp jig 7 clamp the coil end 31. The wall member 6 is disposed in contact with or in close proximity to the surface of the clamp jig 7. In the laser welding standby state, the controller 100 controls the motor 81 to drive and thereby rotate and move the fixing jig 8 to rotate and move the stator core 2 around the central axis and to stop at a predetermined position where the position of the wall member 6 matches a phase of one coil end row 30 including the plurality of coil ends 31 to be welded in the stator core 2 (step S1).

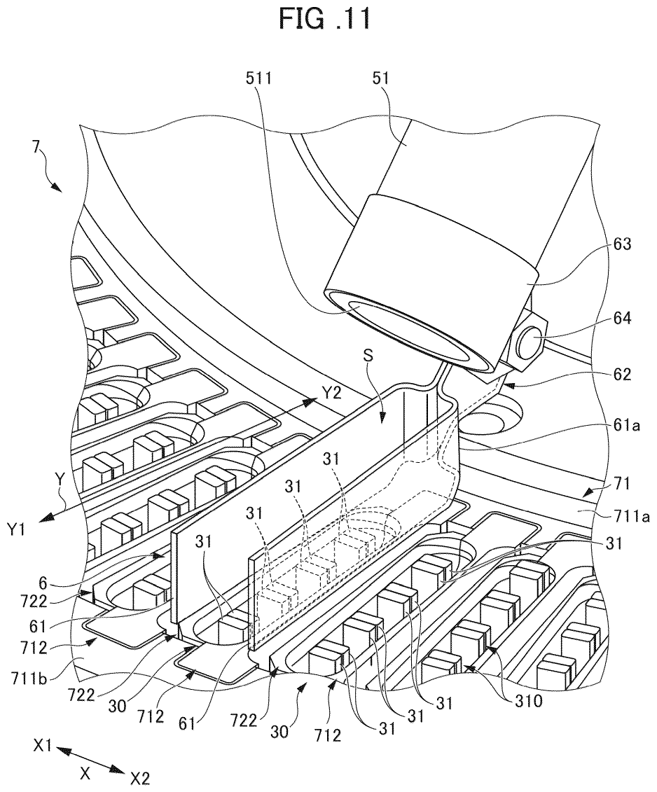

At this time, as illustrated in FIGS. 11 to 13, the wall member 6 is disposed to accommodate one row of the coil end rows 30 between the pair of plate portions 61 and 61, and an upper space S, defined above upper end surfaces of the coil ends, of eight coil ends 31 is sandwiched between the pair of plate portions 61 and 61 from both sides in the circumferential direction X of the stator core 2. The laser irradiator 41 is disposed above the wall member 6, that is, above the coil end row 30. The assist gas injector 51 formed integrally with the wall member 6 is disposed closer to the inside Y2 in the radial direction Y of the stator core 2 relative to the coil end row 30, and the injection port 511 faces the coil end row 30.

Subsequently, the controller 100 drives the laser oscillator 42 and the assist gas supply source 52 to irradiate the welding points 310 at the tips of the two coil ends 31 and 31, which are sandwiched between the pair of plate portions 61 and 61, within the slot 22 with a laser beam and to inject the assist gas from the injection port 511 of the assist gas injector 51, thereby performing welding (step S2). At this time, the laser irradiator 41 uses the scanner to be controlled by the controller 100 to scan and move the laser beam over the pair of two coil ends 31 and 31 as illustrated in FIG. 14, and sequentially welds the welding point 310 including the two coil ends 31 and 31. At the same time, the assist gas injection device 5 injects the assist gas from the injection port 511 at a predetermined injection pressure.

The assist gas injected from the injection port 511 through the assist gas injector 51 flows into the space between the pair of plate portions 61 and 61 of the wall member 6 as indicated by a white arrow in FIG. 14. The assist gas flowing in the space between the pair of plate portions 61 and 61 reduces the oxygen concentration around the joint point, blows away the impurities such as fumes, dust, motes, or spatter generated during the laser welding, and is discharged from the space between the pair of plate portions 61 and 61 by flowing toward the outside Y1 in the radial direction Y of the stator core 2. The wall member 6 restricts the flow of the assist gas in the circumferential direction X of the stator core 2 with the pair of plate portions 61 and 61. Therefore, the blown-away impurities are quickly discharged toward the outside Y1 in the radial direction Y of the stator core 2, thereby reducing the risk that the impurities adhere to the coil ends 31 of the coil end rows 30 which are not to be welded.

The space between the pair of plate portions 61 and 61 of the wall member 6 is smaller than the diameter of the injection port 511 of the assist gas injector 51. For this reason, the ambient gas filling region due to the assist gas also expands around the wall member 6. However, since the assist gas is in a laminar flow state immediately after being injected from the injection port 511, the assist gas flowing on both sides of the pair of plate portions 61 and 61 does not affect the blowing away of the impurities.

The emission of the laser beam and the injection of the assist gas are continued until completion of the laser welding for all of the coil ends 31 of one coil end row 30 in the wall member 6 (step S3). When the laser welding has been completed for all of the coil ends 31 in the wall member 6 (YES in step S3), the controller 100 determines whether the welding work has been completed for all of the coil ends 31 on the stator core 2 (step S4). Whether the welding work has been completed is determined when the controller 100 detects a rotation angle of the stator core 2 and the number of times of rotational movement, for example.

When the welding work has not yet been completed for all of the coil ends 31 on the stator core 2 (NO in step S4), the controller 100 rotates and moves the stator core 2 around the central axis such that the position of the wall member 6 matches the phase of one adjacent coil end row 30 in the stator core 2 (step S5). Thereafter, the controller 100 repeats the process from step S2 above, and ends the laser welding on the stator core 2 when determining in step S4 that the welding work has been completed for all of the coil ends 31 on the stator core 2.

According to the laser welding device 1 and the laser welding method according to the present embodiment, the upper space S of the plurality of coil ends 31 to be welded is sandwiched between the pair of plate portions 61 and 61 of the wall member 6, and thus it is possible to perform the laser welding while injecting the assist gas to the coil ends 31 subjected to the laser welding. Therefore, it is possible to provide an economical laser welding device 1 and laser welding method that can be applied regardless of the type of the stator core 2 without needing to provide a configuration corresponding to the type of the stator core 2.

According to the laser welding device 1 and the laser welding method according to the present embodiment, the assist gas injector 51 is disposed closer to the inside Y2 in the radial direction Y of the stator core 2 in the arrangement direction of the plurality of coil ends 31, and is disposed so as to inject the assist gas in the arrangement direction of the plurality of coil ends 31 sandwiched between the pair of plate portions 61 and 61 of the wall member 6 and obliquely toward the outside Y1 in the radial direction Y of the stator core 2, whereby the fumes, dust, motes, spatter, and the like generated during the laser welding can be smoothly discharged toward the outside Y1 in the radial direction Y of the stator core 2 by injection of the assist gas. Therefore, the risk can be reduced that the fumes, dust, motes, spatter, and the like adhere to other coil ends 31 of the stator core 2.

According to the laser welding device 1 and the laser welding method according to the present embodiment, the interval between the pair of plate portions 61 and 61 of the wall member 6 is open to the outside Y1 in the radial direction Y of the stator core 2, whereby the fumes, dust, motes, spatter, and the like generated during the laser welding can be more smoothly discharged toward the outside Y1 in the radial direction Y of the stator core 2 by injection of the assist gas. Therefore, the risk can be further reduced that the fumes, dust, motes, spatter, and the like adhere to other coil ends 31 of the stator core 2.

According to the laser welding device 1 and the laser welding method according to the present embodiment, the wall member 6 is attached to the assist gas injector 51, whereby the relative position of the wall member 6 and the assist gas injector 51 is fixed. Therefore, by simply positioning the wall member 6 relative to the plurality of coil ends 31 to be welded, the plurality of coil ends 31 and the assist gas injector 51 can also be positioned at the same time.

According to the laser welding device 1 and the laser welding method according to the present embodiment, the mover is provided to move the assist gas injector 51 and the wall member 6 relative to the stator core 2 such that positions of the assist gas injector 51 and the wall member 6 match phases of the plurality of coil ends 31 to be welded in the stator core 2, whereby the assist gas injector 51 and the wall member 6 can be easily matched in phase with the plurality of coil ends 31 to be welded in the stator core 2.

According to the laser welding device 1 and the laser welding method according to the present embodiment, the clamp jig 7 is provided to be disposed on the one end surface 2a of the stator core 2 and grip the plurality of coil ends 31 protruding from the slots 22 from both sides in the circumferential direction X of the stator core 2, the wall member 6 being disposed in contact with or in close proximity to the surface of the clamp jig 7, whereby the plurality of coil ends 31 clamped by the clamp jig 7 can be easily arranged and positioned between the pair of plate portions 61 and 61 of the wall member 6.

In the laser welding device 1 according to the present embodiment, the laser welding device 1 includes one laser irradiator 41, one assist gas injector 51, and one wall member 6, but is not limited thereto. The laser welding device 1 may include two or more sets of the laser irradiator 41, the assist gas injector 51, and the wall member 6, which are disposed at predetermined intervals in the circumferential direction X of the stator core 2, and may be configured to perform the laser welding on the plurality of coil end rows 30 at the same time.

In the laser welding device 1 according to the present embodiment, the wall member 6 is configured such that the pair of plate portions 61 and 61 sandwich the upper space S of one coil end row 30 from both sides in the circumferential direction X, but is not limited thereto. The wall member 6 may be configured such that the pair of plate portions 61 and 61 sandwich the upper space S of two or more adjacent coil end rows 30 from both sides in the circumferential direction X, and may be configured to perform the laser welding on the two or more coil end rows 30 at once.

The laser welding device 1 according to the present embodiment is configured such that, when the wall member 6 and the coil end row 30 are matched in phase, the fixing jig 8 is rotated to rotate and move the stator core 2, but is not limited thereto. The laser welding device 1 may be configured such that the laser irradiator 41, the assist gas injector 51, and the wall member 6 move in the circumferential direction X of the stator core 2 relative to stator core 2 which is immovable, or such that the stator core 2 moves in a direction opposite to the direction of the laser irradiator 41, the assist gas injector 51, and the wall member 6.

### EXPLANATION OF REFERENCE NUMERALS

1 laser welding device
2 stator core
2a one end surface
22 slot
31 coil end
310 welding point
41 laser irradiator
51 assist gas injector
52 assist gas supply source
6 wall member
61 plate portion
7 clamp jig
8 fixing jig (mover)
81 motor (mover)
S upper space

What is claimed is:

1. A laser welding device that welds, for a plurality of coil ends arranged in a radial direction and protruding from slots on at least one end surface in an axial direction of a stator core, the coil ends adjacent to each other, the laser welding device comprising:
a laser irradiator that irradiates a welding point of the plurality of coil ends with a laser beam;
an assist gas injector that is disposed closer to an inside in a radial direction of the stator core in an arrangement direction of the plurality of coil ends and injects an assist gas supplied from an assist gas supply source toward the plurality of coil ends; and
a wall member that is disposed between the one end surface of the stator core and the assist gas injector, includes a pair of plate portions extending in a radial direction of the stator core, and is configured to sandwich an upper space, defined above upper end surfaces of the plurality of coil ends, of the plurality of coil ends to be welded from both sides in a circumferential direction of the stator core with the pair of plate portions.

2. The laser welding device according to claim 1, wherein the assist gas injector is disposed closer to an inside in the radial direction of the stator core in the arrangement direction of the plurality of coil ends, and is disposed so as to inject the assist gas along the arrangement direction of the plurality of coil ends and obliquely toward an outside in the radial direction of the stator core.

3. The laser welding device according to claim 2, wherein a space between the pair of plate portions of the wall member is open to the outside in the radial direction of the stator core.

4. The laser welding device according to claim 1, wherein the wall member is attached to the assist gas injector.

5. The laser welding device according to claim 1, further comprising:
a mover that moves the assist gas injector and the wall member relative to the stator core such that positions of the assist gas injector and the wall member match a phase corresponding to a circumferential position, defined by a slot pitch of the stator core, of the plurality of coil ends to be welded in the stator core.

6. The laser welding device according to claim 1, further comprising:
a clamp jig that is disposed on the one end surface of the stator core and grips the plurality of coil ends protruding from the slots from both sides in the circumferential direction of the stator core,
the wall member being disposed in contact with or in close proximity to a surface of the clamp jig.

7. A laser welding method of welding, for a plurality of coil ends arranged in a radial direction and protruding from slots on at least one end surface in an axial direction of a stator core, the coil ends adjacent to each other with a laser beam emitted from a laser irradiator, the laser welding method comprising:
disposing an assist gas injector that injects an assist gas supplied from an assist gas supply source toward the plurality of coil ends, closer to an inside in a radial direction of the stator core in an arrangement direction of the plurality of coil ends;
disposing a wall member including a pair of plate portions extending in a radial direction of the stator core, between the one end surface of the stator core and the assist gas injector; and
irradiating a welding point of the plurality of coil ends with a laser beam and injecting the assist gas from the assist gas injector toward the plurality of coil ends, in a state where an upper space, defined above upper end surfaces of the plurality of coil ends, of the plurality of coil ends to be welded is sandwiched between the pair of plate portions from both sides in a circumferential direction of the stator core.

8. The laser welding method according to claim 7, further comprising:
disposing the assist gas injector closer to an inside in the radial direction of the stator core in the arrangement direction of the plurality of coil ends, and injecting the assist gas to the plurality of coil ends in a state where a direction of a central axis of the assist gas injector coincides with the arrangement direction of the plurality of coil ends sandwiched between the pair of plate portions and is inclined obliquely toward an outside in the radial direction of the stator core.

9. The laser welding method according to claim 8, wherein a space between the pair of plate portions of the wall member is open to the outside in the radial direction of the stator core.

10. The laser welding method according to claim 7, wherein the wall member is attached to the assist gas injector.

11. The laser welding method according to claim 7, further comprising:
moving, before laser irradiation, the assist gas injector and the wall member relative to the stator core such that positions of the assist gas injector and the wall member match a phase corresponding to a circumferential position, defined by a slot pitch of the stator core, of the plurality of coil ends to be welded in the stator core, thereby performing phase matching.

12. The laser welding method according to claim 7, further comprising:
disposing the wall member in contact with or in close proximity to a surface of a clamp jig disposed on the one end surface of the stator core in a state where the plurality of coil ends protruding from the slots are gripped by the clamp jig from both sides in the circumferential direction of the stator core.
